(19) United States
(12) Patent Application Publication
(10) Pub. No.: US 2013/0098535 A1
(43) Pub. Date: Apr. 25, 2013

(54) METHOD AND APPARATUS FOR FORMING A COATING ON A LINING OF A CONDUIT IN SITU

(71) Applicant: Larry W. Kiest, JR., Ottawa, IL (US)

(72) Inventor: Larry W. Kiest, JR., Ottawa, IL (US)

(73) Assignee: LMK ENTERPRISES, INC., Ottawa, IL (US)

(21) Appl. No.: 13/276,366

(22) Filed: Oct. 19, 2011

(51) Int. Cl. B32B 7/04; B32B 1/08

(52) U.S. Cl. 156/91; 428/35.2; 156/215

(57) ABSTRACT

The present invention relates to a method and apparatus for repairing the wall of a conduit where a coating is placed onto a conduit lining using a non-absorbent bladder preferably made of polyurethane and material capable of curing and hardening, such as a grout or thermoset resin, preferably an epoxy. The coating is to be formed on the conduit lining after the lining is placed against the walls of the conduit. The non-absorbent bladder and the material capable of curing and hardening should be compatible for adhesion. The material capable of curing and hardening is placed between the wall of the pipe and the non-absorbent bladder by an inversion technique, and the non-absorbent bladder permanently bonds to the material capable of curing and hardening.

### FIELD OF THE INVENTION

This invention relates to a method and apparatus for repairing the wall of a pipe. More particularly, but not exclusively, it relates to a method and device for forming a coating on a conduit lining using a non-absorbent bladder preferably made of polyurethane and material capable of curing and hardening, such as a grout or thermoset resin, preferably an epoxy. The coating is to be formed on the conduit lining after the lining is placed against the walls of the conduit. The non-absorbent bladder and the material capable of curing and hardening should be compatible for adhesion. The material capable of curing and hardening is disposed between the wall of the pipe and the bladder, the bladder expands to conform to the wall of the pipe, and the non-absorbent bladder permanently bonds to the material capable of curing and hardening.

### BACKGROUND OF THE INVENTION

Pipes and conduits have been restored for many years using a variety of rehabilitation and pipelining techniques. Some rehabilitation techniques act as structural reinforcement to the existing conduit, thus extending the useful life of the conduit. Other rehabilitation techniques simply provide a sealing or protective function and are intended to prevent corrosion or leaks in the conduit instead of providing structural reinforcement. There are also some rehabilitation techniques that provide both a structural reinforcement and act to seal and protect conduits.

A well-known method of rehabilitating a pipe or other conduit is the use of spin-casting, where a mortar or cement is flung onto the walls of a pipe using an apparatus including a nozzle capable of spinning in a full circle. The mortar or cement is then troweled or smoothed to create an even surface. Examples of such methods may be found in U.S. Pat. Nos. 2,181,361; 4,252,763; 4,506,624; and 5,650,103. Such methods have been widely used to provide corrosion resistance to metal pipes, as those pipes have tendency to corrode and release harmful metals or other solids into the pipeline, contaminating the fluid in transport. Even though a spin casting technique does provide corrosion resistance to pipes, the weight of the mortar may affect the longevity of the pipe or conduit. Furthermore, the mortar will create an even yet rough surface in the interior of the pipe, which may result in a flow rate through the pipe that is slower than desired, due to a high coefficient of friction of the pipe interior.

Cured-in-place pipe (CIPP) repair has been used to repair or rehabilitate pipes or other types of conduits. Usually, a fabric liner tube is impregnated with a resinous material and is positioned in a pipe adjacent a damaged area of pipe. The impregnated fabric liner tube is pressed against the wall of the damaged area of the pipe by the use of a bladder, and the resin is allowed to cure. The bladder is then removed from the pipe, creating a renewed pipe wall. A fabric liner tube may be coated with an impermeable film prior to impregnation. Fabric liners that include impermeable coatings are commonly called “coated liners” and are disclosed in some form in U.S. Pat. Nos. 4,714,095; 5,653,555; 7,112,254; and 7,270,150.

When a coated liner is used in CIPP, several problems may arise during the installation of the lining. One common problem is bunching of the coated liner during inflation of the bladder. Bunching of the fabric liner is due to the fact that the coating restricts movement of the fabric within the space between the pipe wall and the bladder. The bunched areas of the liner cure as folds, protrusions, or irregularities on the surface of the cured-in-place pipe, requiring a technician or robot to smooth the surface to allow unobstructed pipe flow. A second problem commonly encountered when using a coated liner is separation of the coating from the cured-in-place pipe. Such separation may result in the coating completely falling into the renewed pipe, obstructing pipe flow, or requiring removal of the coating from the pipe system. Alternatively, air pockets may form between the coating and the liner. The air pockets may form due to at least two reasons: incomplete impregnation of the liner fabric; or release of a gas by certain resins during or after the polymerization process, a phenomenon called “gassing off” of the resin. When air pockets are present in the cured liner, weak areas may exist in the liner and/or the coating may act to obstruct pipe flow. A third problem that arises when using a coated liner is that the coating may degrade depending on the material used for the coating and the type of fluid present in the pipe or conduit.

In addition to the problems associated with using a coated liner during installation, there are several problems associated with the manufacture of tubular coated liners. In the conventional method of manufacture, a layer of fabric is laid flat and a polymeric coating is applied to one side of the fabric. The process of applying the coating in a manufacturing facility may be labor-intensive and expensive because a layer of heated polymeric material is generally extruded or pressed onto a liner fabric. The liner fabric is usually thinned during the application of the coating, as the heated material compresses or burns layers of the liner fabric. For example, a felt fabric liner having a thickness of 8 mm may have a thickness of approximately less than 6 mm after the coating is applied. After the liner fabric is coated, the coated fabric is then cut into sections that are tailored to the inner profile a conduit to be rehabilitated, and the sections are sewn together at their ends to form the shape of a tube. The seam may then be taped and heat welded for reinforcement. U.S. Pat. Nos. 5,242,517; 6,136,135; 6,562,426; and 7,112,254 include some form of this method.

Since the fabric is coated with an impermeable layer, several issues arise in the production of the liner tube. There are two basic methods of creating a seam for a liner tube. The first method is the use of an abutment seam. In such a seam, the ends of the liner fabric to be sewn together abut each other and the abutment is sewn. When this seam is used on a coated fabric liner, the abutment of the liner fabric must be such that the fabric and coating align before the ends are sewn. If the fabric and coating are not aligned, the liner tube will not cure together as a full tube within the conduit. The deficiency occurs because pressure is applied to the seam of the tube as the liner is placed against the conduit walls. The pressure creates a void area between the ends of the tube that eventually fills with resin. When the resin has cured, the void area is weaker than the surrounding area of the lining. The second method of creating a seam includes overlapping the ends of the coated fabric liner and sewing a seam along the overlapping region. If an overlapping seam is used on a coated liner, the coating will prevent full integration of the resin into the liner at the seam, creating a cold joint. Furthermore, penetration of the coating or impermeable layer with sewing needles and thread creates areas where resin is able to flow through the coating.

In light of the aforementioned problems with known methods of creating a lining for a conduit, there is a need in the art for a method of lining a conduit capable of providing structural reinforcement, full sealing of leaks, and a protective barrier from corrosion.

### BRIEF SUMMARY OF THE INVENTION

It is therefore a principal object, aspect, feature and/or advantage of the present invention to provide an apparatus and method for creating a lining for a conduit that improves over or solves the problems and deficiencies in the art.

Other objects, features, aspects, and/or advantages of the present invention relate to an apparatus and method that achieves providing a coating to a conduit lining within the conduit.

Further objects, features, aspects, and/or advantages of the present invention relate to a new method of repairing a conduit wherein a curable and hardenable material is applied to the wall and an impermeable coating is applied to the outer surface of the material.

Still further objects, features, aspects, and/or advantages of the present invention relate to a new method of repairing a conduit wherein an impermeable coating is formed about the conduit wall and adhered thereto with a chemical bond, mechanical bond, or a chemical bond.

Still further objects, features, aspects, and/or advantages of the present invention relate to a new method of repairing a conduit wherein a resin-impregnated liner that does not include an impermeable coating is pressed against the conduit wall with an inflatable non-absorbent bladder, and an impermeable coating is formed by bonding the resin-impregnated liner to the inflatable non-absorbent bladder as the resin cures.

A still further object, feature, aspect and/or advantage of the present invention relates to a method and apparatus for repairing a conduit that accommodates diameter changes along the wall.

A still further object, feature, and/or advantage of the present invention is to provide an improved liner tube for lining a pipe that will not substantially stretch longitudinally, but that will allow for radial stretching, and forming the liner tube by overlapping the ends of the liner tube and sewing the overlapping area to create a seam.

A still further object, feature, and/or advantage of a method of the present invention is to provide a coated lining to a conduit that allows free movement of the liner and the material capable of curing and hardening within the pipe, resulting in a substantially wrinkle-free, unbunched, smooth lining.

A still further object, feature, and/or advantage of the present invention relates to the provision of coating that protects a conduit lining against chemical or water damage by the use of ester or ether grade materials for the coating.

These and other objects, features, aspects, and/or advantages of the present invention will become apparent with reference to the accompanying specification and claims.

One aspect of the invention includes an apparatus for forming a coating to a lining of a conduit. The apparatus includes an uncoated liner impregnated with a material capable of curing and hardening and a non-absorbent bladder comprising a polyurethane. The non-absorbent bladder should be inflatable and unreinforced. The uncoated liner is surrounded by and unbonded to the non-absorbent inflatable bladder and the uncoated liner is formed into a tube. The material capable of curing and hardening is preferably an epoxy.

Another aspect of the present invention includes a method of forming a coating to a lining of a conduit where an uncoated liner impregnated with a material capable of curing and hardening is introduced into the conduit. The uncoated liner is pressed against a wall of the conduit with a non-absorbent bladder; and a bond is formed between the non-absorbent bladder and the material capable of curing and hardening while inside the conduit. The non-absorbent bladder should be inflatable and unreinforced. The material capable of curing and hardening is preferably an epoxy and the non-absorbent bladder is preferably made of polyurethane. The uncoated liner is preferably formed into the shape of a tube. The uncoated liner preferably has a seamless construction or includes an overlapping seam.

The present invention as disclosed herein provides numerous advantages. For example, the non-absorbent inflatable bladder is not removed from the wall of the conduit, providing a permanent impermeable barrier or coating to the conduit lining. Additionally, since the coating is applied to an uncoated liner while inside the conduit, the difficult step of applying a coating to a liner in a manufacturing facility is no longer required, reducing the cost of the conduit lining. Furthermore, since several problems associated with using a coated liner while lining a conduit, such as bunching, are alleviated, the quality of the coated conduit lining is enhanced.

### BRIEF DESCRIPTION OF THE DRAWINGS

FIG. 1 is a sectional view of a conduit that has been lined utilizing the methods and apparatus of this invention.

FIG. 2a is a perspective view of a flat sheet used in accordance with one embodiment of the present invention to form a liner tube.

FIG. 2b is a cross-sectional view of the sheet shown in FIG. 2a, illustrating an overlapping seam used to create the liner tube according to an embodiment of the present invention.

FIG. 2c is a perspective view of a liner tube as completed by the method shown in FIGS. 2a and 2b.

FIG. 3 is a sectional view of a lining assembly in accordance with an embodiment of the present invention.

FIGS. 4a-4b are sectional views of the lining assembly of FIG. 3 where the lining assembly is prepared for installation within a conduit.

FIGS. 5a-5c are sectional views illustrating a method of installation in accordance with an embodiment of the present invention.

FIG. 6 is a sectional view of a surface modification to a non-absorbent bladder of the present invention.

FIG. 7 is a sectional view similar to FIG. 6 of a further modification of the non-absorbent bladder of the present invention.

FIG. 8 is a sectional view similar to FIG. 6 showing a further modification of the non-absorbent bladder of the present invention.

### DETAILED DESCRIPTION OF THE PREFERRED EMBODIMENT

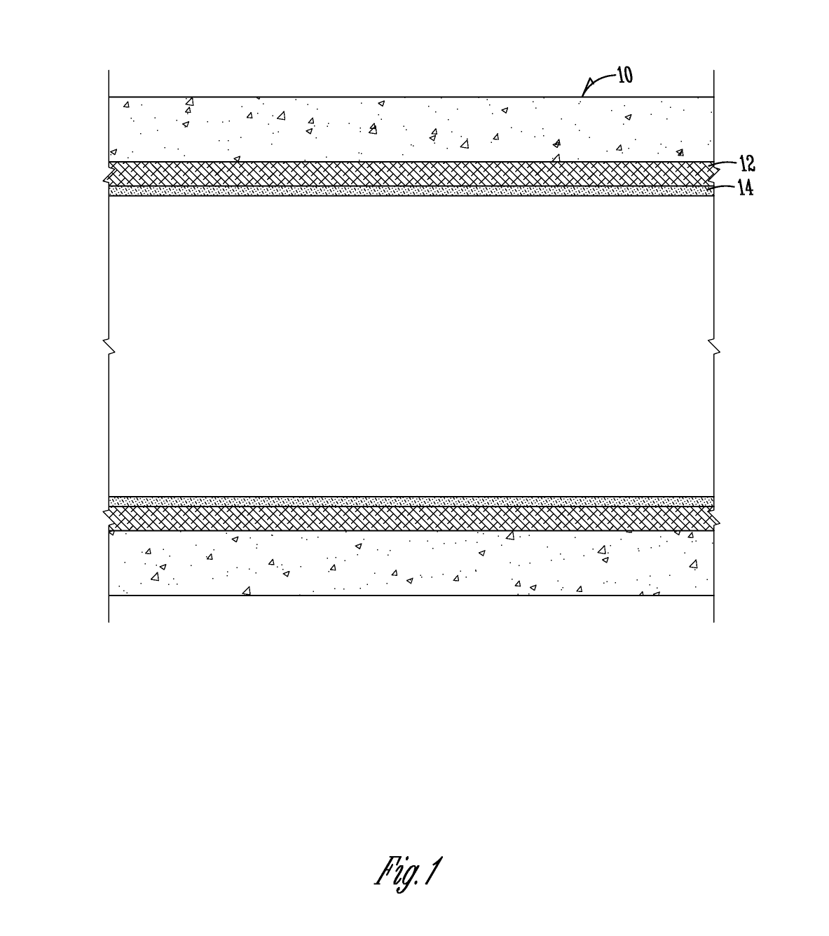

Referring now to the drawing wherein like numerals refer to like parts, FIG. 1 shows a preferred embodiment of a lined conduit 10 of the present invention, where a liner 12 and an integral coating 14 have been positioned in the conduit 10. It should be noted that liner 12 and integral coating 14 were unbonded prior to insertion into the conduit 10. Conduit 10 may be a low-pressure pipe, such as a sewer pipe or HVAC duct; a pressurized pipe, such as a potable water pipe or gas line; or a conduit for the transport of other materials, such as electrical conduit. Embodiments of the present invention may withstand pressures greater than 1,000 psi. The liner 12 comprises at least a material capable of curing and hardening. The material capable of curing and hardening must be compatible for adhesion with integral coating 14.

Integral coating 14 is a non-absorbent inflatable bladder. A non-absorbent bladder is a generally an inflatable, expandable, fluid and resin impervious film. Because the non-absorbent bladder is expandable, the material preferably does not include a scrim or fiber reinforcement. Therefore, the non-absorbent bladder is said to be unreinforced. The non-absorbent bladder may be a sheet of thermoplastic, preferably polyurethane, that is formed into the shape of a tube. A fluid is used to inflate the non-absorbent bladder to press the liner 12 against the walls of the conduit 10. The non-absorbent bladder does not include an impregnable or intermediate layer in the embodiments of this invention.

In some embodiments of the present invention, the liner 12 is constructed of an uncoated impregnable material or fabric that has been formed into the shape of a tube. An uncoated impregnable material or fabric is a material that does not include an impermeable layer, such as an impermeable polymeric layer. The liner 12 is constructed of woven or non-woven material, such as felt, carbon fiber, Kevlar®, fiberglass, or a woven knitted sheet. In such embodiments, the liner 12 is formed into the shape of a tube prior to insertion within the conduit 10. For example, the liner 12 may be of a seamless knitted construction or may be formed of seamless felt tube. Alternatively, the liner 12 is formed into the shape of a tube from a flat sheet and attached at opposite ends by a stitching, sewing, or welding method or the like.

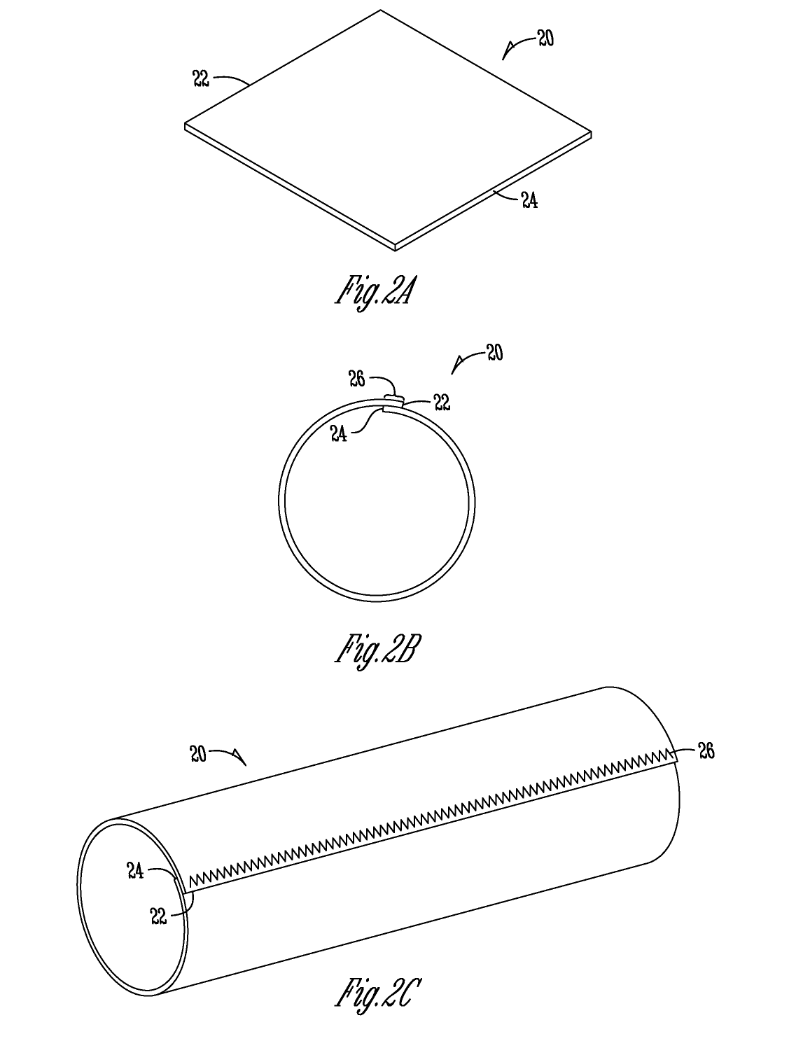

FIGS. 2a-2c illustrate the construction of such an uncoated liner 20 having an overlapping seam 26. FIG. 2a shows where the uncoated liner 20 made of a woven or non-woven material is in the form of a flat sheet, having opposite sides 22 and 24. The ends of opposite sides 22 and 24 are overlapped along the length of the liner 20. FIG. 2b shows a cross-sectional view of the liner 20 illustrating the overlapping seam 26. FIG. 2c shows where the ends of opposite sides 22 and 24 of the liner 20 have been overlapped and attached at the seam 26 using methods known in the art, such as stitching, sewing, or heat welding.

One of the advantages of using an uncoated seamless liner tube or an uncoated liner tube having an overlapping seam is that weak spots are not formed in the cured lining. Weak spots occur due to the properties of coated lining material. When a coated liner is formed into a tube, the ends must abut one another and align in a so-called “butt seam.” The ends of the coated liner are sewn together to form a tube and the stitching area is taped and heat welded. Once the coated liner is impregnated with a resinous material, placed into a pipe and cured, the area where the ends of the liner abut is weaker than the rest of the body of the liner. The weak spot in the lining is created because the area of the butt seam does not include a liner impregnated with resin; it is usually simply a thin layer of resin, which is prone to breakage when the resin expands/contracts. In addition, if a coated liner is overlapped and stitched together, a weak spot is formed after curing of the liner, because the coating will not allow full integration of the resin and liner at the seam, thus creating a cold joint. Therefore, the use of an uncoated seamless liner tube or an uncoated liner tube having an overlapping seam provides the best structural integrity for a cured lining.

Additionally, the uncoated liner 20 may have many constructions, provided that there is no impermeable coating on the material of the liner. For example, the uncoated liner 20 may comprise a first layer having strands of a non-stretching material oriented in the longitudinal direction of the liner tube, at least a second layer comprising an impregnable uncoated material disposed on a first side of the first layer, and an optional third layer comprising an impregnable uncoated material disposed on a side of the first layer opposite the second layer. The layered liner construction will ensure that the uncoated liner 20 covers only a predetermined length of the conduit, as the liner tube will be limited in longitudinal stretch. The limit of the longitudinal stretch is attributable to the first layer comprising strands of substantially non-stretching material oriented in a longitudinal direction. An example of such a liner is disclosed in U.S. patent application Ser. No. 12/959,044, which is hereby incorporated by reference in its entirety.

FIG. 3 shows a sectional view of a lining assembly 30 in accordance with a first embodiment of the present invention for forming a coating to a lining of a conduit is shown. The lining assembly 30 has a first end 36 and a second end 38. The lining assembly 30 further includes an uncoated liner 32 that has been formed into the shape of a tube and impregnated with a material capable of curing and hardening. In a preferred embodiment, the material capable of curing and hardening comprises an epoxy. However, the material capable of curing and hardening may be any material compatible for full adhesion or integration with the material of the non-absorbent bladder. The liner 32 is surrounded by and unbonded to a non-absorbent inflatable bladder 34 comprising a polyurethane. It is noted that the use of epoxy and polyurethane are preferred for the material capable of curing and hardening and the non-absorbent bladder, respectively, because most epoxy resins and thermoplastic polyurethanes are compatible for full adhesion. Because an epoxy will permanently bond to a thermoplastic polyurethane after the epoxy cures and hardens, the non-absorbent inflatable bladder 34 will become an integral part of the lining after it has cured within a conduit. It is noted that in most embodiments of the present invention, non-absorbent inflatable bladder 34 should be translucent to allow technicians to view the placement of the liner 32 within the non-absorbent inflatable bladder 34 and observe the level of impregnation of the liner 32 with the material capable of curing and hardening.

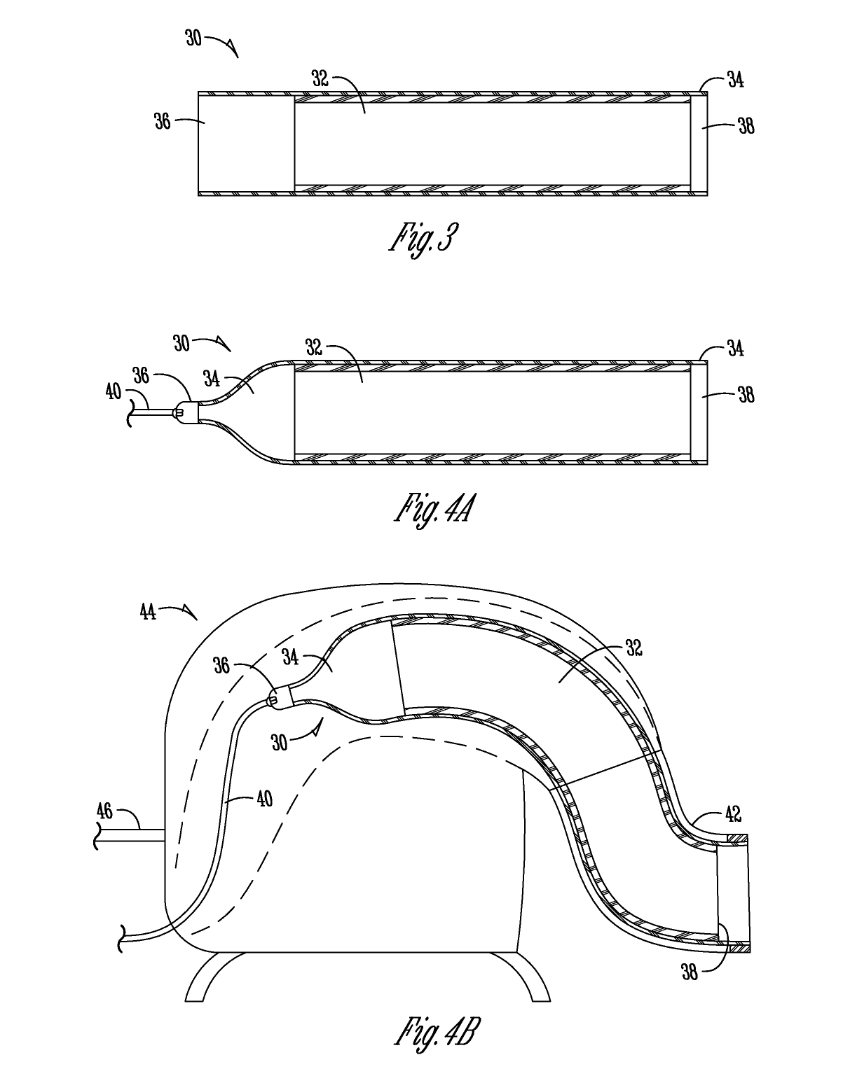

FIGS. 4a-4b are perspective views of the lining assembly 30 of FIG. 3 where the lining assembly is prepared for installation within a conduit. In order to prepare the lining assembly 30 for installation, the first end 36 of the lining assembly 30 is closed by the use of clamps, tape, or other the like. A control rope or line 40 is attached to the closed first end of the lining assembly 30, as shown in FIG. 4a. The control rope or line 40 provides a controlled inversion and can alert a technician when the assembly is fully inverted within the conduit. The second end 38 of the lining assembly is attached to a unit that applies pressure to the exterior of the lining assembly 30, such that the lining assembly may invert into the conduit to be lined. In the embodiment illustrated in FIG. 4b, the second end 38 is attached to a hose 42 of an inversion vessel 44 after pulling the first end 36 of the lining assembly 30 into the inversion vessel 44 by the rope or line 40. The second end 38 may be attached to the hose 42 by banding, taping, cam locks, or the like. The inversion vessel 44 also includes a fluid line 46 that supplies fluid pressure to the inversion vessel 44. The fluid may be hydraulic fluid, water, air, steam, and/or other fluids. The hose 42 is aligned with an access bore of the conduit to be lined, pressure is supplied to the inversion vessel 44 via fluid line 46, and the lining assembly 30 is inverted into the conduit to be lined.

In operation of an embodiment of the invention, a method of forming a coating to a lining of a conduit includes inserting an uncoated liner impregnated with a material capable of curing and hardening into the conduit; pressing the uncoated liner against a wall of the conduit with a non-absorbent inflatable bladder; and forming a bond between at least a portion of the non-absorbent inflatable bladder and the material capable of curing and hardening while inside the conduit. In such embodiments, steam or heat may be introduced into the conduit during the curing process to promote integration of the non-absorbent bladder to the material capable of curing and/or hardening. Once the material is fully cured and/or hardened, areas of the lining that are unnecessary are cut away and removed from the conduit.

The insertion of the uncoated liner impregnated with a material capable of curing and hardening into the conduit may be achieved by an inversion, push-in-place, or pull-in-place process. The inversion process may include inversion of the uncoated liner with the inflatable bladder simultaneously as an assembly under fluid pressure into the conduit (a so-called “one-step inversion” process), or inversion of the uncoated liner into the conduit under fluid pressure followed by inversion of the inflatable bladder under fluid pressure (a so-called “two-step inversion” process). Alternatively, the uncoated liner impregnated with a material capable of curing and hardening may be pulled or pushed into place in the conduit and the inflatable bladder may be inverted or otherwise inserted through the liner.

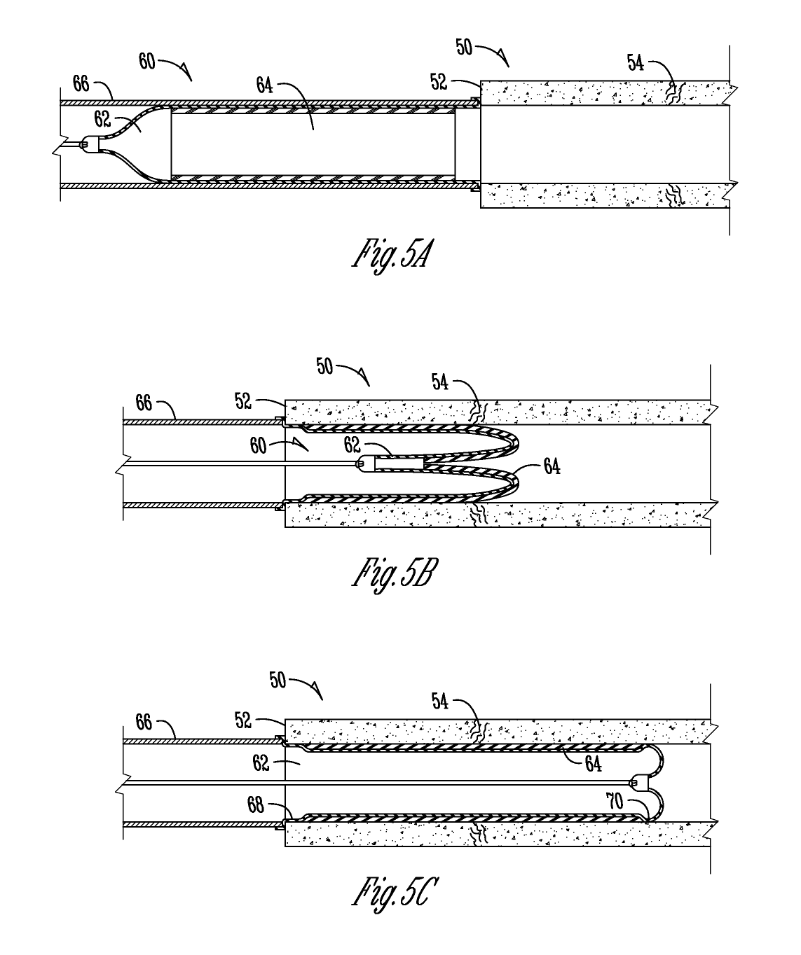

FIGS. 5a-5c illustrate a method of forming a coating to a lining of a conduit utilizing a one-step inversion process where an uncoated liner impregnated with a material capable of curing and hardening is inverted with the inflatable bladder simultaneously as an assembly under fluid pressure into the conduit. FIG. 5a shows where a conduit in need of repair 50 having an access bore 52 and a damaged area 54 has a lining assembly 60 comprising a non-absorbent bladder 62 and a liner 64 aligned with the access bore 52. The liner 64 comprises at least a material capable of curing and hardening and an uncoated fabric liner. The lining assembly is shown positioned within an inverter 66. FIG. 5b illustrates the lining assembly 60 during inversion into the conduit in need of repair 50. During the inversion step, air or another fluid is introduced into the inverter 66, which inverts the lining assembly 60 into the conduit in need of repair 50. The liner 64 is positioned at and pressed against the walls of the conduit in need of repair 50 by the non-absorbent bladder 62 and held in place until the material capable of curing and hardening is allowed to cure and harden. FIG. 5c shows where the material capable of curing and hardening has cured and hardened and the non-absorbent bladder 62 has attached to the liner 64, becoming a coating to the conduit lining. It should also be noted that the material capable of curing and hardening may penetrate into damaged area 54 and act to seal the damage. When an uncoated liner is utilized, structural reinforcement is provided to the conduit in need of repair 50 as well. After the material capable of curing and hardening has cured and hardened, the portions of the non-absorbent bladder 62 that have not attached to the liner 64 are cut away using a razor or cutting robot at the cutting points 68, 70.

It should be noted that the material used for the non-absorbent bladder is a thermoplastic polyurethane having a thickness of 0.1-1,000 mils, with a preferred range of 1-100 mils. The material should not be limited to a thermoplastic polyurethane, but it should be a thermoplastic compatible for adhesion with the material capable of curing and hardening. It should also be noted that the non-absorbent bladder material may be a polyurethane that is an ester grade or ether grade material. An ether grade material is best suited for applications where the conduit transports water and other aqueous effluents, as ether grade thermoplastic material does not degrade in aqueous conditions. An ester grade material is best suited for applications where the conduit transports natural gas, oil, or other organic effluents, as ester grade thermoplastic material does not degrade in the presence of organic materials or solvents.

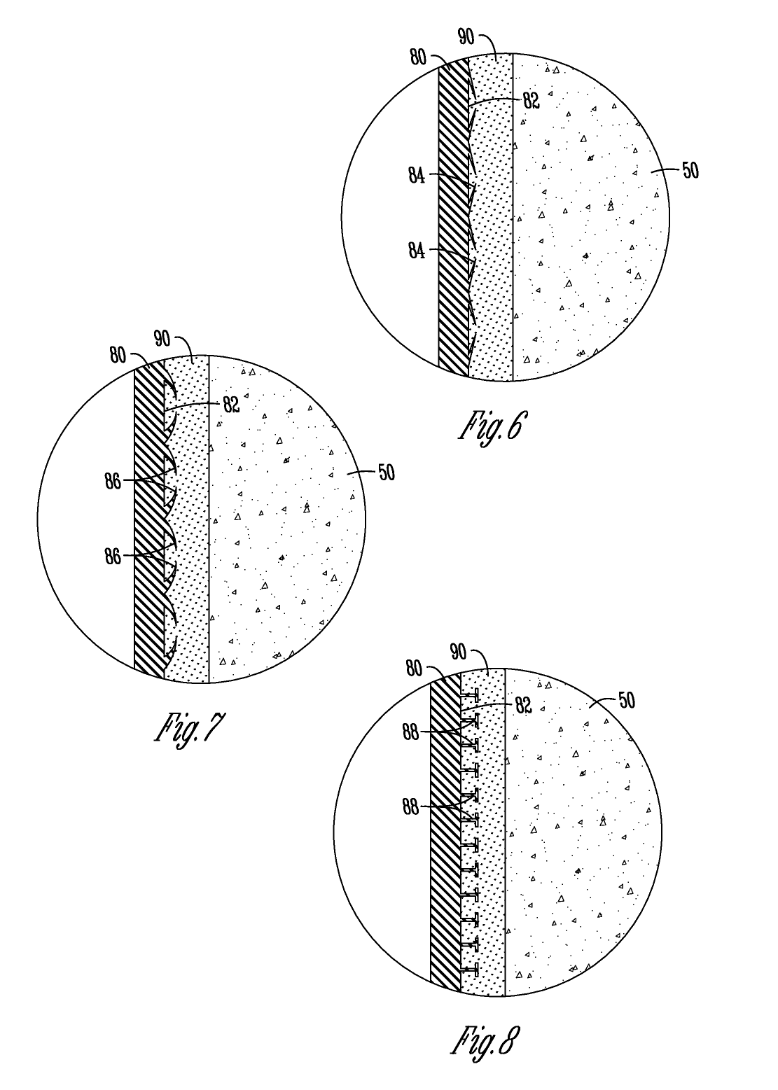

In most embodiments, the non-absorbent inflatable bladder is chemically bonded to the material capable of curing and hardening as an adhesive bond. Additionally, the non-absorbent bladder may become an impermeable coating or barrier to the lining by the use of a mechanical bond. The mechanical bond may be formed by the use of an uneven bladder surface. In such an embodiment, the bladder surface preferably includes a plurality of projections or protrusions. Such projections or protrusions may be straight pointed projections extending in opposite directions that embed within the material capable of curing and hardening. Alternatively, the projections or protrusions may be curved pointed projections, or T-shaped projections. Projections having other shapes may be used to create a mechanical bond between the bladder and the material capable of curing and hardening. Referring to FIG. 6, a surface 82 of the non-absorbent bladder 80 includes straight pointed projections 84 extending in opposite directions and embedded in curable and/or hardenable material 90. FIG. 7 shows a plurality of curved pointed projections 86, and FIG. 8 illustrates T-shaped projections 88. All of the projections 84, 86 and 88 provide a mechanical bond between the non-absorbent bladder 80 and the curable and/or hardenable material 90, as the projections 84, 86, 88 become embedded and trapped within the curable and/or hardenable material 90 once the curable and/or hardenable material cures and hardens. It should be appreciated, however, that projections having other shapes can be used to create a mechanical bond between the non-absorbent bladder 80 and curable and/or hardenable material 90 as well.

The projections depicted in FIGS. 6-8 are formed when the bladder material is made by an extrusion process. In such a process, raw material for forming the bladder is extruded through a series of rollers and allowed to set. At least one of the rollers may be embossed with a texture to impart the projections onto the material. Alternatively, an uneven surface may be created by abrading the material of the non-absorbent bladder with sandpaper, pumice stone, or the like prior to formation of the lining assembly.

The result of practicing the embodiments and methods of this invention is a lining to a conduit where a coating is attached to the lining within the conduit. The coating provides a smooth surface for effluents to travel through the conduit with little resistance due to friction. Additionally, the liner used to form the conduit lining is not constricted during installation, therefore very few bulges or bunches will appear in the cured conduit lining. Additionally, the coating will not separate or fall into the conduit, as practicing the methods of this invention allows the coating to remain within the lined conduit permanently when optimal materials are chosen for the coating and lining.

The invention has been shown and described above with the several embodiments, and it is understood that many modifications, substitutions, and additions may be made which are within the intended spirit and scope of the invention. From the foregoing, it can be seen that the present invention accomplishes at least all of its stated objectives.

What is claimed is:

1. A lining assembly for forming a coating to a lining of a conduit, comprising:
an uncoated liner impregnated with a material capable of curing and hardening;
wherein the material capable of curing and hardening comprises an epoxy; and
a non-absorbent, unreinforced inflatable bladder comprising a polyurethane;
wherein the uncoated liner is surrounded by and unbonded to the non-absorbent unreinforced inflatable bladder;
wherein the uncoated liner is in a tubular shape.

2. The lining assembly of claim 1, wherein the uncoated liner is formed into the tubular shape by attaching a first end of the uncoated liner to an opposite second end of the uncoated liner.

3. The lining assembly of claim 2, wherein the first end of the uncoated liner overlaps the opposite second end.

4. The lining assembly of claim 1, wherein the uncoated liner comprises a seamless tube.

5. The lining assembly of claim 1, wherein the conduit comprises a pressurized pipe.

6. The lining assembly of claim 1, wherein the conduit comprises a low-pressure pipe.

7. The lining assembly of claim 1, wherein the conduit comprises a sewer pipe or potable water pipe and the non-absorbent unreinforced inflatable bladder comprises an ether-grade polyurethane.

8. The lining assembly of claim 1, wherein the conduit comprises a gas pipe or oil pipe and the non-absorbent unreinforced inflatable bladder comprises an ester-grade polyurethane.

9. A method of forming a coating to a lining of a conduit comprising:
inserting an uncoated liner impregnated with a material capable of curing and hardening into the conduit;
positioning the uncoated liner against a wall of the conduit using a non-absorbent unreinforced inflatable bladder; and
forming a bond between at least a portion of the non-absorbent unreinforced inflatable bladder and the material capable of curing and hardening while inside the conduit.

10. The method of claim 9, wherein the uncoated liner impregnated with a material capable of curing and hardening is inserted into the conduit by the use of an inversion technique.

11. The method of claim 10, wherein the non-absorbent unreinforced inflatable bladder is inverted simultaneously with the uncoated liner impregnated with a material capable of curing and hardening.

12. The method of claim 10, wherein the material capable of curing and hardening comprises an epoxy and wherein the non-absorbent unreinforced inflatable bladder comprises a thermoplastic polyurethane.

13. The method of claim 12, wherein the uncoated liner is formed into a tube by stitching a first end of the uncoated liner to a second end of the uncoated liner.

14. The method of claim 13, wherein the first end of the uncoated liner overlaps the second end.

15. The method of claim 14, wherein the uncoated liner is a seamless fabric tube.

16. The method of claim 9, wherein the bond is a chemical bond.

17. The method of claim 16, wherein the bladder is sized equal or less than the smallest cross-section of the conduit.

18. The method of claim 9, wherein the bond comprises a mechanical bond.

19. The method of claim 18, wherein the mechanical bond is formed by a plurality of projections on a surface of the non-absorbent unreinforced inflatable bladder.

20. The method of claim 19, wherein the projections are hook-like shaped projections.

21. The method of claim 9, wherein the uncoated liner comprises a first layer comprising strands of a substantially non-stretching material oriented in a longitudinal direction of the uncoated liner, and a second layer comprising an absorbent material;
wherein the liner tube is capable of radial expansion.

22. The method of claim 21, wherein the fabric liner tube further comprises a third layer comprising an absorbent material disposed on a side of the first layer opposite the second layer.

23. The method of claim 9, wherein the conduit comprises a sewer pipe, an HVAC duct, or a natural gas pipe.

24. The method of claim 9, further comprising removing portions of the non-absorbent bladder unattached to the conduit after the bond is formed.

25. The method claim 9, wherein the conduit comprises a pressurized pipe.

26. The method claim 9, wherein the conduit comprises a low-pressure pipe.

27. The method claim 9, wherein the conduit comprises a sewer pipe or potable water pipe and the non-absorbent unreinforced inflatable bladder comprises an ether-grade polyurethane.

28. The method claim 9, wherein the conduit comprises a gas pipe or oil pipe and the non-absorbent unreinforced inflatable bladder comprises an ester-grade polyurethane.

29. A method of lining a conduit, comprising:
providing a lining assembly comprising a fluid impermeable bladder and an uncoated liner impregnated with a material capable of curing and hardening, the liner at least partially surrounding the bladder;
positioning the lining assembly within a conduit with the liner adjacent a wall of the conduit;
allowing the material to cure and harden; and
removing a portion of the bladder such that at least a portion of the bladder remains in the conduit adjacent the liner.

30. The method of claim 29, further comprising providing an inverter, wherein the lining assembly is everted into the inverter before positioning the lining assembly within the conduit.

31. The method of claim 30, wherein the lining assembly is inverted from within the inverter to within the conduit to position the lining assembly within the conduit.

32. The method of claim 29, further comprising pressing a plurality of projections from the bladder into the liner before allowing the material to cure and harden.

33. The method of claim 29, further comprising allowing at least a portion of the bladder to remain in the conduit with the liner between a wall of the conduit and the bladder such that the bladder provides an impermeable coating to the liner.
